(19) United States
(12) Patent Application Publication
(10) Pub. No.: US 2021/0197549 A1
(43) Pub. Date: Jul. 1, 2021

(54) IMAGE FORMING APPARATUS

(71) Applicant: KYOCERA Document Solutions Inc., Osaka-shi (JP)

(72) Inventors: Kohei FURUKAWA, Osaka-shi (JP); Shinichiro Yamada, Osaka-shi (JP)

(21) Appl. No.: 17/133,740

(22) Filed: Dec. 24, 2020

(30) Foreign Application Priority Data
Dec. 27, 2019 (JP) 2019-238409

(51) Int. Cl. B41J 2/045; B41J 2/155; B41J 2/165

(52) U.S. Cl. CPC B41J 2/04536; B41J 2/16517; B41J 2/04581; B41J 2/155

(57) ABSTRACT

An image forming apparatus includes a linehead and a control unit. The linehead of an image forming apparatus includes a common ink chamber, a plurality of nozzles, an individual ink flow path, an ink supply path, a first piezoelectric actuator, and a second piezoelectric actuator. One end of the individual ink flow path is connected to the nozzle. The ink supply path is connected to the individual ink flow path and the common ink chamber. When putting the nozzle into a drying prevention state, the control unit deforms the first piezoelectric actuator in a direction in which a capacity of the individual ink flow path increases, to thereby draw an interface of ink to inside the nozzle. Further, the control unit deforms the second piezoelectric actuator, to thereby close the ink supply path.

### INCORPORATION BY REFERENCE

This application is based upon, and claims the benefit of priority from, corresponding Japanese Patent Application No. 2019-238409 filed in the Japan Patent Office on Dec. 27, 2019, the entire contents of which are incorporated herein by reference.

### BACKGROUND

### Field of the Invention

This disclosure relates to an image forming apparatus that discharges ink to form an image.

### Description of Related Art

There is an image forming apparatus that discharges ink from a nozzle of a head and performs printing. The ink contains an evaporative component. For example, a solvent of the ink evaporates (vaporizes). The ink near the discharge port of the nozzle comes into contact with air. In the nozzle without discharge for a long time, the component of the ink evaporates and the viscosity of the ink increases. When the viscosity continues to increase, the ink may not be discharged from the nozzle (clogging). To prevent drying, the head's surface for installing the nozzle is, as the case may be, covered with a cap.

### SUMMARY

An image forming apparatus according to this disclosure includes a linehead and a control unit for controlling the linehead. The linehead includes a common ink chamber, a plurality of nozzles, an individual ink flow path, an ink supply path, a first piezoelectric actuator, and a second piezoelectric actuator. The individual ink flow path is provided for each of the plurality of nozzles. One end of the individual ink flow path is connected to the nozzle of the plurality of nozzles. The ink supply path is provided for each individual ink flow path. One end of the ink supply path is connected to the other end of the individual ink flow path, and the other end of the ink supply path is connected to the common ink chamber. The first piezoelectric actuator is provided for the individual ink flow path. The first piezoelectric actuator is capable of deforming in a direction in which a capacity of the individual ink flow path increases and in a direction in which the capacity of the individual ink flow path decreases. The second piezoelectric actuator is provided for the ink supply path When putting the nozzle into a drying prevention state, the control unit deforms the first piezoelectric actuator in the direction in which the capacity of the individual ink flow path increases, to thereby draw an interface of ink to inside the nozzle. And, the control unit deforms the second piezoelectric actuator, to thereby cause the second piezoelectric actuator to close the ink supply path connected to the individual ink flow path in which the interface of the ink was drawn.

### BRIEF DESCRIPTION OF THE DRAWINGS

FIG. 1 is a diagram showing an example of a printer according to an embodiment;

FIG. 2 is a diagram showing an example of the printer according to the embodiment;

FIG. 3 is a diagram showing an example of a linehead according to the embodiment;

FIG. 4 is a diagram showing an example of a cross-sectional view of a head according to the embodiment;

FIG. 5 is a diagram showing an example of a cross-sectional view of the head according to the embodiment;

FIG. 6 is a diagram showing an example of a cross-sectional view of the head according to the embodiment;

FIG. 7 is a diagram showing an example of drying prevention control during printing by the printer according to the embodiment;

FIG. 8 is a diagram showing an example of setting the timing of transition to and release from the drying prevention state; and

FIG. 9 is a diagram showing an example of the drying prevention control when the printing job of the printer according to the embodiment is completed.

### DETAILED DESCRIPTION

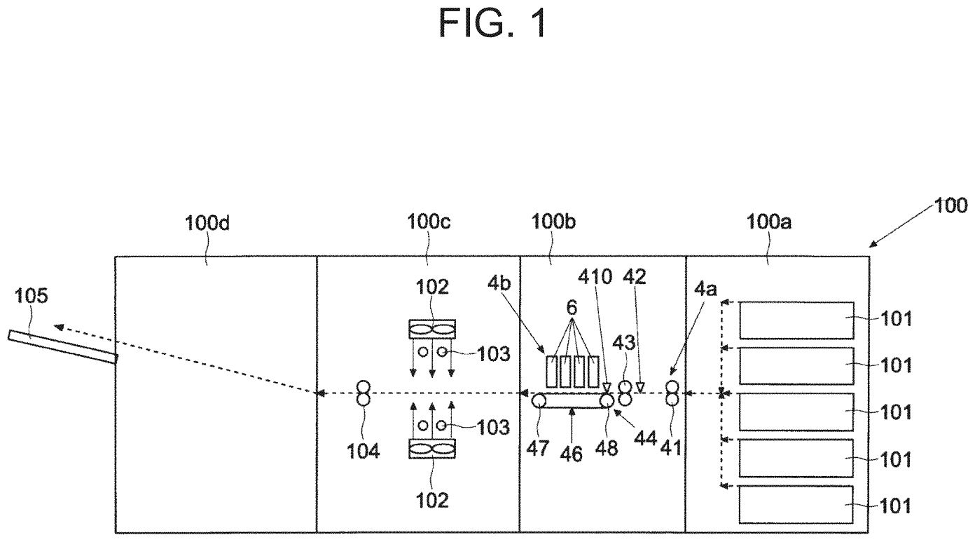

Hereinafter, embodiments of this disclosure will be described with reference to FIGS. 1 to 9. An image forming apparatus according to the embodiment performs printing by using ink. In the following, a printer 100 will be taken as an example of the image forming apparatus. This disclosure is also applicable to any image forming apparatus other than a printer, such as a complex machine.

### (Overview of Printer 100)

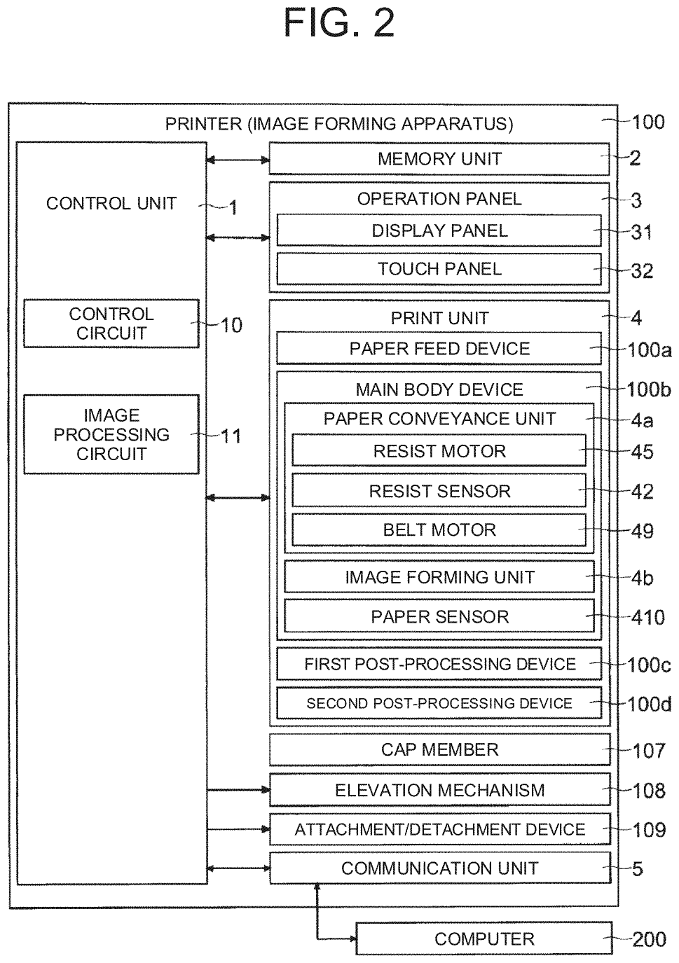

First, the outline of the printer 100 according to the embodiment will be described, with reference to FIGS. 1 and 2. FIGS. 1 and 2 are diagrams showing an example of the printer 100 according to the embodiment.

As shown in FIG. 1, the printer 100 includes a paper feed device 100a, a main body device 100b, a first post-processing device 100c, and a second post-processing device 100d. In FIG. 1, the broken line arrow indicates a paper conveyance direction. The paper feed device 100a and the main body device 100b are coupled (connected). The main body device 100b and the first post-processing device 100c are coupled (connected). The first post-processing device 100c and the second post-processing device 100d are coupled (connected).

The paper feed device 100a includes a plurality of paper feed cassettes 101. Each paper feed cassette 101 stores paper. At the time of printing, a control unit 1 causes the paper to be supplied from any of the paper feed cassettes 101. One paper feed roller is provided for one paper cassette 101. At the time of printing, the paper feed roller of the paper feed cassette 101 that feeds the paper rotates. The paper feed device 100a conveys the supplied paper toward the main body device 100b.

The main body device 100b performs printing on paper. The main body device 100b performs printing by using ink. The first post-processing device 100c is a device that dries and decals (remove curl of) the paper. For drying the ink, the first post-processing device 100c includes a fan 102 and a heater 103. The fan 102 blows wind to the paper printed by the main body device 100b. The heater 103 warms the air to be blown to the paper. This dries the ink. Further, the first post-processing device 100c includes a pair of decal rollers 104. The pair of decal rollers 104 applies a pressure to the paper. The second post-processing device 100d discharges the paper to a discharge tray 105. The second post-processing device 100d can reverse the front and back of the paper so that the print surface turns downward.

As shown in FIG. 2, the printer 100 includes the control unit 1, a memory unit 2, an operation panel 3, a print unit 4, and a communication unit 5. The control unit 1, the memory unit 2, the operation panel 3, and the communication unit 5 are provided at the main body device 100b.

The control unit 1 controls each part of the printer 100. The control unit 1 is a board including a control circuit 10 and an image processing circuit 11. For example, the control circuit 10 is a CPU. Based on a control program and control data stored in the memory unit 2, the control circuit 10 performs calculations and processing. The image processing circuit 11 performs image processing of the image data used for printing and generates an ink discharge image data D1. The memory unit 2 includes a non-volatile memory device such as ROM and storage (HDD and flash ROM). In addition, the memory unit 2 includes a volatile memory device such as RAM.

The printer 100 includes the operation panel 3. The operation panel 3 includes a display panel 31 and a touch panel 32. The control unit 1 causes the display panel 31 to display a setting screen and information. The display panel 31 displays an operation image such as a key, a button, and a tab. The touch panel 32 detects a touch operation to the display panel 31. Based on the output of the touch panel 32, the control unit 1 recognizes any operated operation image. The control unit 1 recognizes the setting operation performed by a user.

The printer 100 includes the print unit 4. The print unit 4 includes the paper feed device 100a, a part of the main body device 100b, the first post-processing device 100c, and the second post-processing device 100d. The main body device 100b includes a paper conveyance unit 4a and an image forming unit 4b as the print unit 4. When performing a printing job, the control unit 1 controls the operation of the print unit 4.

The operation panel 3 accepts a selection of the paper feed cassette 101 used for printing. At the time of the printing job, the control unit 1 rotates the paper feed roller of the selected paper feed cassette 101. The control unit 1 causes the paper to enter into the paper conveyance unit 4a of the main body device 100b. The paper conveyance unit 4a conveys the paper toward the image forming unit 4b. As shown in FIGS. 1 and 2, the main body device 100b is provided with a pair of conveyance rollers 41, a resist sensor 42, a pair of resist rollers 43, and a conveyance unit 44, as the paper conveyance unit 4a, sequentially from the upstream side in the paper conveyance direction. A resist motor 45 is provided to rotate the pair of resist rollers 43. The control unit 1 controls the rotation of the resist motor 45, to thereby control the rotation of the pair of resist rollers 43.

The main body device 100b includes the resist sensor 42. The resist sensor 42 is provided on the upstream side in the paper conveyance direction from the pair of resist rollers 43. The output level of the resist sensor 42 changes depending on whether or not presence of paper is detected. The output of the resist sensor 42 is input to the control unit 1. Based on the output of the resist sensor 42, the control unit 1 recognizes that the front end of the paper has arrived at the resist sensor 42. Further, the control unit 1 recognizes that the rear end of the paper has passed through the resist sensor 42.

When the paper arrives at the pair of resist rollers 43, the control unit 1 keeps the pair of resist rollers 43 stopped. For example, when the rear end of the previous paper passes through the resist sensor 42, the control unit 1 stops the pair of resist rollers 43. On the other hand, the control unit 1 rotates the pair of conveyance rollers 41 one step on the upstream side of the pair of resist rollers 43. The front end of the paper hits the pair of resist rollers 43. The hit paper bends, and the front end of the paper follows a nip of the pair of resist rollers 43. The skew of the paper is corrected. After recognizing the arrival of the front end of the paper based on the output of the resist sensor 42, the control unit 1, with an elapse of a specific bend-forming time, rotates the pair of resist rollers 43. This causes the paper to be sent out to the conveyance unit 44.

The conveyance unit 44 includes a conveyance belt 46, a drive roller 47, and a follower roller 48. The conveyance belt 46 is hung around the drive roller 47 and the follower roller 48. A belt motor 49 is provided so as to rotate the drive roller 47. During the printing job, the control unit 1 rotates the belt motor 49 and causes the conveyance belt 46 to orbit. Further, the conveyance belt 46 suctions the paper. A plurality of holes is opened in the conveyance belt 46. For example, there is provided a suction device for suctioning air from the holes. Suctioning can fix the position of the paper during the printing.

The image forming unit 4b perform the printing on fed paper. In other words, the image forming unit 4b discharges the ink to the fed paper and records an image. As shown in FIGS. 1 and 2, the image forming unit 4b includes four lineheads 6. Of the lineheads 6, one discharges black, one yellow, one cyan, and one magenta ink. Each linehead 6 is fixed. Each linehead 6 is provided above the conveyance belt 46. A certain gap is provided between each linehead 6 and the conveyance belt 46. The paper passes through this gap.

The linehead 6 includes a plurality of nozzles 7. The nozzles 7 are arranged in a direction (main scanning direction) (direction perpendicular to the paper surface in FIG. 1) perpendicular to the paper conveyance direction. An opening of each nozzle 7 faces the conveyance belt 46. To the linehead 6, the control unit 1 supplies the ink discharge image data D1 for the printing. Based on the ink discharge image data D1, the linehead 6 discharges the ink from the nozzle 7 to the fed paper. The ink lands on the fed paper. This records (forms) the image.

A paper sensor 410 is provided on the upstream side of the linehead 6. The paper sensor 410 detects the arrival of the front end of the paper and the passage of the rear end of the paper. The paper sensor 410 is a sensor for determining the timing for starting the printing of the page. The output of the paper sensor 410 is input to the control unit 1. Based on the output of the paper sensor 410, the control unit 1 recognizes that the front end of the paper has arrived at the paper sensor 410. After recognizing the arrival of the front end, the control unit 1, with an elapse of a specific waiting time, starts the ink discharge (drawing an image) of the first line at the linehead 6. The waiting time is determined for each linehead 6. For example, the waiting time is defined as the time obtained by dividing the distance from the paper detection position of the paper sensor 410 to the nozzle 7 of the linehead 6 by a specified paper conveyance speed.

The control unit 1 is connected with the communication unit 5. The communication unit 5 includes a communication connector, a communication control circuit, and a communication memory. The communication memory memorizes a communication software. The communication unit 5 communicates with a computer 200. The computer 200 is, for example, a PC or a server. The control unit 1 receives print data from the computer 200. The print data includes print settings and print contents. For example, the print data includes the data described in a page description language. The control unit 1 (image processing circuit 11) analyzes the received (input) print data. Based on the received print data, the control unit 1 generates the image data (raster data). The control unit 1 processes the generated image data to thereby generate the ink discharge image data D1.

### (Linehead 6)

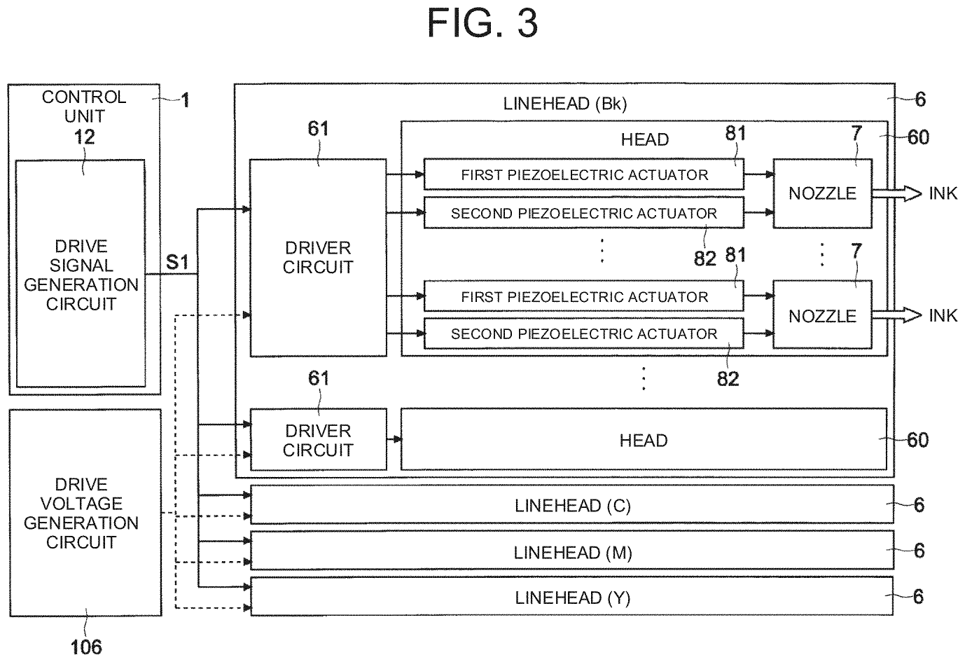

Next, an example of the linehead 6 according to the embodiment will be described, with reference to FIG. 3. FIG. 3 is a diagram showing an example of the linehead 6 according to the embodiment. Note that the configuration of the linehead 6 of each color is the same. Therefore, in the following description, the black linehead 6 will be used as an example. Description of the black linehead 6 also applies to each of the cyan, magenta, and yellow lineheads 6.

The one-color linehead 6 includes two or more (a plurality of) heads 60. In other words, the linehead 6 is a combination of a plurality of heads 60. In the one-color linehead 6, each head 60 is arranged in a row or staggered pattern in the main scanning direction.

Each head 60 includes a plurality of nozzles 7. Each nozzle 7 is arranged in the main scanning direction (direction perpendicular to the paper conveyance direction). The nozzles 7 are formed so that the intervals in the main scanning directions are even. The ink is discharged from the opening of the nozzle 7. Each head 60 is fixed so that the nozzles 7 are arranged in the main scanning direction.

One first piezoelectric actuator 81 and one second piezoelectric actuator 82 are provided for one nozzle 7. That is, the linehead 6 includes a plurality of first piezoelectric actuators 81 and a plurality of second piezoelectric actuators 82. Each piezoelectric actuator 82 includes a piezoelectric element. For example, the piezoelectric element is a piezo element. For example, each piezoelectric actuator is a stack of piezoelectric elements. Each piezoelectric actuator is deformed by application of a driving voltage.

The linehead 6 includes one or more driver circuits 61. FIG. 3 shows an example in which one driver circuit 61 is provided for each head 60. The driver circuit 61 turns ON/OFF the voltage application to each first piezoelectric actuator 81. The driver circuit 61 turns ON/OFF the voltage application to each second piezoelectric actuator 82. The driver circuit 61 actually controls deformation of each piezoelectric actuator based on the instruction of the control unit 1.

At the time of printing job, the control unit 1 gives the ink discharge image data D1 (data indicating the nozzle 7 to discharge the ink) to each driver circuit 61. The ink discharge image data D1 is data (binary data) for instructing discharge and non-discharge of the ink. For example, the control unit 1 (image processing circuit 11) transmits the ink discharge image data D1 to each driver circuit 61 per one line unit in the main scanning direction.

Based on the ink discharge image data D1, the driver circuit 61 applies a drive voltage to the first piezoelectric actuator 81 of the nozzle 7 to discharge the ink. The application of the drive voltage deforms the first piezoelectric actuator 81. Deformation pressure is applied to the flow path (details will be described later) that supplies the ink to the nozzle 7. The pressure to the flow path causes the ink to be discharged from the nozzle 7. On the other hand, the driver circuit 61 does not apply any drive voltage to the first piezoelectric actuator 81 of the nozzle 7 that corresponds to the pixel which does not discharge the ink.

The printer 100 includes a drive voltage generation circuit 106. The drive voltage generation circuit 106 generates a plurality of types of voltages having different magnitudes. For example, the drive voltage generation circuit 106 includes a plurality of power supply circuits having different output voltages. The output voltage of each of the voltage generation circuits 106 is input to each driver circuit 61 (shown by a broken line in FIG. 3). The driver circuit 61 uses the drive voltage supplied from the drive voltage generation circuit 106 to thereby apply a voltage to the first piezoelectric actuator 81 and the second piezoelectric actuator 82. For example, by changing the magnitude of the drive voltage applied to the first piezoelectric actuator 81, the driver circuit 61 can adjust the ink amount (droplet amount) to be discharged.

Further, the control unit 1 includes a drive signal generation circuit 12. The drive signal generation circuit 12 generates a drive signal S1. The drive signal S1 is a signal for periodically discharging the ink. The drive signal S1 is, for example, a clock signal. The head 60 (driver circuit 61) discharges the ink every time the drive signal S1 rises or falls once. A reference cycle of the ink discharge is specified in advance. The control unit 1 causes the drive signal generation circuit 12 to generate the drive signal S1 of the reference cycle. Then, the paper conveyance unit 4a conveys the paper by a distance of one pixel per cycle of the drive signal S1. This processing is repeated from the beginning to the end of the page in the paper conveyance direction (sub-scanning direction), thereby printing one page.

### (Nozzle 7, and Ink Flow Path)

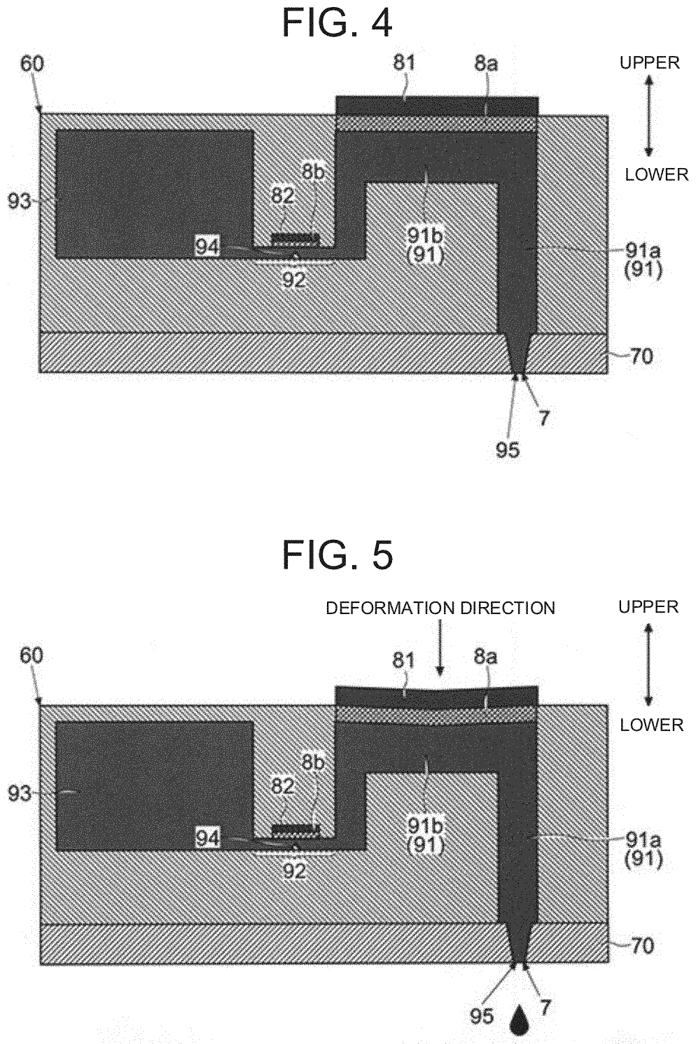

Next, an example of the nozzle 7 and an ink flow path according to the embodiment will be described, with reference to FIG. 4. FIG. 4 is a diagram showing an example of a cross-sectional view of the head 60 according to the embodiment.

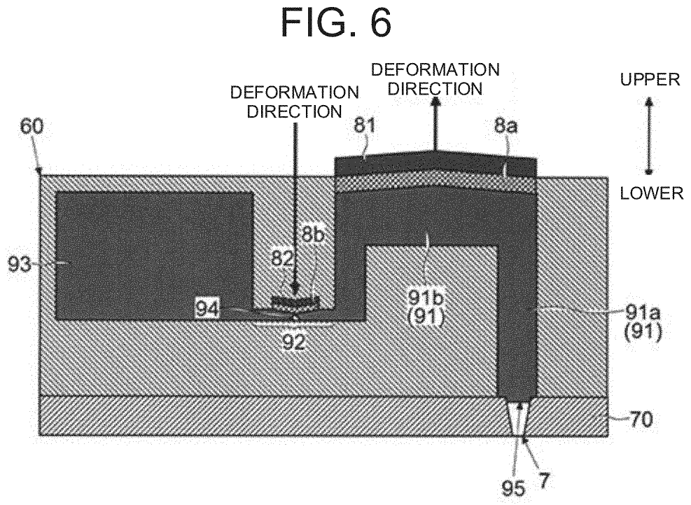

FIG. 4 shows an example of a cross section of the head 60 cut along the paper conveyance direction (the short side direction of the head 60) so as to pass through the nozzle 7, as viewed from the main scanning direction (direction perpendicular to the paper conveyance direction) (The same applies to FIG. 5 and FIG. 6). And, inside the head 60, there are provided the nozzle 7, an individual ink flow path 91, an ink supply path 92, a common ink chamber 93, the first piezoelectric actuator 81, and the second piezoelectric actuator 82.

A nozzle layer 70 (nozzle plate) is mounted to the lower surface of the head 60. The plurality of nozzles 7 are provided on the nozzle layer 70 along the main scanning direction. The nozzle 7 shown in FIG. 4 is one of the plurality of nozzles 7. One nozzle 7 has openings on the upper and lower sides. The ink is discharged from the opening on the lower side (the side facing the paper).

The opening on the upper side of the nozzle 7 is connected to one end of the individual ink flow path 91. The individual ink flow path 91 is provided for each nozzle 7. In the example of FIG. 4, the individual ink flow path 91 has an inverted L shape (inverted U shape). The individual ink flow path 91 includes a descender 91a and a cavity 91b. Of the individual ink flow paths 91, the descender 91a is an ink flow path connected to the nozzle 7 and extending in the vertical direction (upper and lower directions). Of the individual ink flow path 91, the cavity 91b is an ink flow path extending in the horizontal direction (paper conveyance direction). The cavity 91b is a part where a pressure is applied by the first piezoelectric actuator 81. In the example of FIG. 4, the first piezoelectric actuator 81 is provided above the cavity 91b.

The other end of the individual ink flow path 91 is connected to one end of the ink supply path 92. The ink supply path 92 is, as the case may be, called a supply. The ink supply path 92 is thinner than the individual ink flow path 91. The ink supply path 92 is provided for each individual ink flow path 91. In the example of FIG. 4, the ink supply path 92 is a pipe extending in the paper conveyance direction (horizontal direction).

The common ink chamber 93 is connected with the other end of each ink supply path 92. The common ink chamber 93 is, as the case may be, called a manifold. Each ink supply path 92 is connected near the bottom surface of the common ink chamber 93. The common ink chamber 93 is provided along the main scanning direction of the head 60. The common ink chamber 93 is provided so that the ink arrives at all the nozzles 7 from one end to the other end in the main scanning direction.

The ink of the common ink chamber 93 is supplied to the nozzle 7 via the ink supply path 92 and the individual ink flow path 91. The common ink chamber 93 is connected with a tank (not shown). Even when the ink is consumed, the water head difference causes the ink of the tank to flow into the common ink chamber 93. The ink of the common ink chamber 93 is supplied to each individual ink flow paths 91 and each nozzle 7 via the ink supply path 92. The ink is supplied to all the nozzles 7 without any shortage or excess.

The first piezoelectric actuator 81 is mounted to the upper side (upper surface) of the individual ink flow path 91 (cavity 91b). The first piezoelectric actuator 81 is provided for each individual ink flow path 91 (for each nozzle 7). Specifically, a first electrode plate 8a is provided on the upper side of the individual ink flow path 91 (cavity 91b). The first piezoelectric actuator 81 is mounted on the upper side of the first electrode plate 8a. The first electrode plate 8a is, for example, a thin metal plate. When deforming the first piezoelectric actuator 81, the driver circuit 61 applies a voltage to the first electrode plate 8a.

The vertical positional relation between the first electrode plate 8a and the first piezoelectric actuator 81 may be reversed. The first piezoelectric actuator 81 may be provided on the upper side of the individual ink flow path 91. In this case, the first electrode plate 8a is mounted on the upper side of the first piezoelectric_actuator 81.

Further, although not shown in FIG. 4, a first common electrode is provided. The first electrode plate 8a and the first common electrode sandwich the first piezoelectric actuator 81 in the vertical direction. The first common electrode has a contact with each piezoelectric actuator 81. For example, the first common electrode is grounded.

Applying a voltage to the first electrode plate 8a causes the first piezoelectric actuator 81, for example, to be curved. The control unit 1 instructs the deformation direction of the first piezoelectric actuator 81 and thereby can control the deformation of the first piezoelectric actuator 81.

For example, when a positive or negative voltage is applied to the first electrode plate 8a, the first piezoelectric actuator 81 deforms into an upwardly convex shape. According to this deformation, the first electrode plate 8a and the individual ink flow path 91 also deform in shape. With the deformation into the upwardly convex shape, the capacity of the individual ink flow path 91 increases. In this way, the first piezoelectric actuator 81 can deform into a direction in which the capacity of the individual ink flow path 91 increases.

In addition, when a voltage having a polarity opposite to that shown with the first piezoelectric actuator 81 deformed into the upwardly convex shape is applied to the first electrode plate 8a, the first piezoelectric actuator 81 is deformed into a downwardly convex shape. According to this deformation, the first electrode plate 8a and the individual ink flow path 91 are also deformed in shape. With the deformation into the downwardly convex shape, the capacity of the individual ink flow path 91 becomes smaller. In this way, the first piezoelectric actuator 81 can be deformed in the direction in which the capacity of the individual ink flow path 91 becomes smaller.

In addition, the second piezoelectric actuator 82 is mounted on the upper side (upper surface) of the ink supply path 92 (supply). The second piezoelectric actuator 82 is provided for each ink supply path 92 (for each nozzle 7). Specifically, the second electrode plate 8b is provided on the upper side of the ink supply path 92. The second piezoelectric actuator 82 is mounted on the upper side of the second electrode plate 8b. The second electrode plate 8b is, for example, a thin metal plate. The control unit 1 can instruct the driver circuit 61 to apply a voltage to the second electrode plate 8b (deformation of the second piezoelectric actuator 82).

The vertical positional relation between the second electrode plate 8b and the second piezoelectric actuator 82 may be reversed. The second piezoelectric actuator 82 may be provided on the upper side of the ink supply path 92. In this case, the second electrode plate 8b is mounted on the upper side of the second piezoelectric actuator 82. Although not shown in FIG. 4, a second common electrode is provided. The second electrode plate 8b and the second common electrode sandwich the second piezoelectric actuator 82 in the vertical direction. The second common electrode is in contact with each second piezoelectric actuator 82. For example, the second common electrode is grounded.

When deforming the second piezoelectric actuator 82, the driver circuit 61 applies a voltage to the 2nd electrode plate 8b. By applying the voltage, the second piezoelectric actuator 82 is, for example, curved. The driver circuit 61 deforms the second piezoelectric actuator 82 into a downwardly convex shape. To the second electrode plate 8b, the driver circuit 61 applies a voltage having a polarity for deforming the second piezoelectric actuator 82 in a downwardly convex direction.

The ink supply path 92 can be closed by applying a voltage to the second piezoelectric actuator 82 (second electrode plate 8b). Applying the voltage to the second piezoelectric actuator 82 can prevent the ink from entering from the common ink chamber 93 to the individual ink flow path 91. It is possible to block the ink flow from the common ink chamber 93 toward the nozzle 7.

A protrusion 94 is provided on the ink supply path 92. In the portion of the ink supply path 92, where the protrusion 94 is located, the passage through which the ink flows is narrowed. The protrusion 94 protrudes in the direction toward the second piezoelectric actuator 82. The protrusion 94 protrudes in the direction facing the direction in which the second piezoelectric actuator 82 at the time of deformation applies a pressure to the ink supply path 92. The protrusion 94 is so provided that, of the second piezoelectric actuator 82 (second electrode plate 8b), the place where deformation amount in the vertical direction at the time of voltage application is the largest and the apex of the protrusion 94 face each other. By applying a voltage to the second electrode plate 8b, the second electrode plate 8b comes into contact with the protrusion 94. This closes the ink supply path 92.

### (Ink Discharge Operation)

Next, an example of the ink discharge operation at the nozzle 7 according to the embodiment will be described, with reference to FIG. 5. FIG. 5 is a diagram showing an example of a cross-sectional view of the head 60 according to the embodiment.

When discharging the ink, it is necessary to push out the ink from the nozzle 7. Therefore, the control unit 1 deforms the first piezoelectric actuator 81 corresponding to the nozzle 7 that discharges the ink so that the capacity of the individual ink flow path 91 becomes small. With the deformation, the control unit 1 applies a pressure to the individual ink flow path 91.

In order to pop out the ink, the control unit 1 may deform the first piezoelectric actuator 81 in the direction in which the capacity of the individual ink flow path 91 increases, and then may deform the first piezoelectric actuator 81 in the direction in which the capacity of the individual ink flow path 91 decreases. In the example of FIG. 5, the control unit 1 may deform the first piezoelectric actuator 81 upward and then downward. Using the reaction of movement of the ink, an operator can tear off a droplet from a mass of the ink (liquid).

When discharging the ink, the control unit 1 does not deform the second piezoelectric actuator 82. In other words, the control unit 1 does not cause the driver circuit 61 to apply a voltage to the second piezoelectric actuator 82. The control unit 1 does not close the ink supply path 92.

### (Drying Prevention State)

Next, an example of the drying prevention state of the nozzle 7 according to the embodiment will be described, with reference to FIG. 6. FIG. 6 is a diagram showing an example of a cross-sectional view of the head 60 according to the embodiment.

The ink of the nozzle 7 (discharge port) portion is in contact with air. Any component of the ink evaporates due to the contact with air. For example, the solvent of the ink evaporates. The component of the liquid decreases. As the evaporation progresses, the viscosity of the ink in the nozzle 7 becomes high. If the viscosity becomes too high, clogging will occur. Drying of the ink in the nozzle 7 is one of the causes for clogging of the nozzle 7.

In the printer 100, the nozzle 7 can be put into the drying prevention state by using the first piezoelectric actuator 81 and the second piezoelectric actuator 82. By putting the nozzle 7 into the drying prevention state, the evaporation of ink in the nozzle 7 can be reduced. It is possible to prevent the occurrence of clogging.

When putting the nozzle 7 into the drying prevention state, the control unit 1 deforms the first piezoelectric actuator 81. As shown in FIG. 6, the control unit 1 deforms the first piezoelectric actuator 81 which corresponds to the nozzle 7 to be put into the drying prevention state, in the direction in which the capacity of the individual ink flow path 91 increases. As a result, as shown in FIG. 6, an interface 95 (a boundary between air and ink) of the ink is drawn to inside the nozzle 7.

Further, when putting the nozzle 7 into the drying prevention state, the control unit 1 deforms the second piezoelectric actuator 82. As shown in FIG. 6, the control unit 1 causes the second piezoelectric actuator 82 to close the ink supply path 92 connected to the individual ink flow path 91 in which the interface 95 of the ink was drawn.

The second piezoelectric actuator 82 closes the ink supply path 92. Although the capacity of the individual ink flow path 91 has increased, the ink does not flow from the ink supply path 92 into the individual ink flow path 91. Therefore, the interface 95 of the ink is kept in a state of being drawn to inside the nozzle 7.

Further, when achieving the drying prevention state, the first piezoelectric actuator 81 and the second piezoelectric actuator 82 may be deformed (voltage applied) at the same time. Also, deformation (voltage application) of the first piezoelectric actuator 81 may be started after the ink supply path 92 is closed by deforming (voltage application) the second piezoelectric actuator 82.

It is known that the evaporation of the ink can be suppressed by drawing the liquid level (interface 95) of the ink to inside the nozzle 7. With the liquid level drawn to inside the nozzle 7, the nozzle 7 becomes hollow. The ink component that evaporated from the liquid surface and vaporized stays in the cavity of the nozzle 7. In the minute space (cavity of nozzle 7) between the air and the ink, there is formed a gas layer containing a high-concentration component evaporated from the ink. It is thought that this gas layer makes it difficult for the component to evaporate from the liquid level of the ink.

### (Drying Prevention Control During Printing)

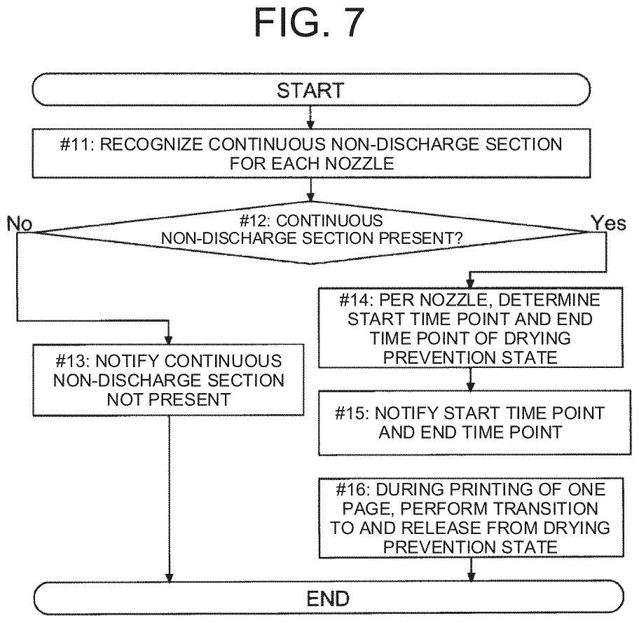

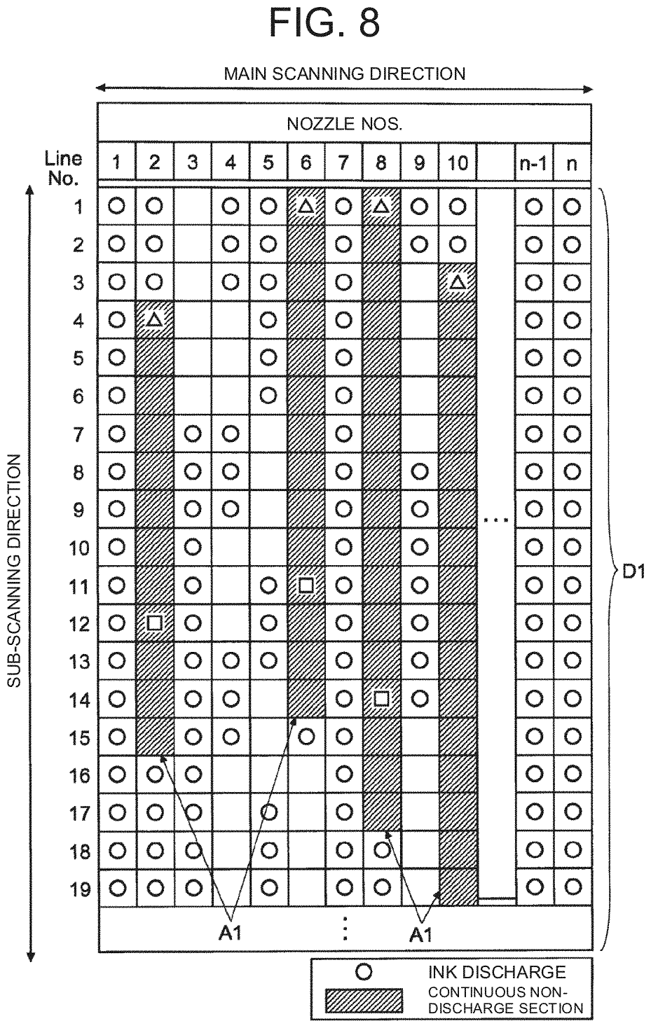

Next, an example of the drying prevention control during the printing by the printer 100 according to the embodiment will be described, with reference to FIGS. 7 and 8. FIG. 7 is a diagram showing an example of the drying prevention control during the printing by the printer 100 according to the embodiment. FIG. 8 is a diagram showing an example of setting the timing of transition to and release from the drying prevention state based on an image analysis.

Based on the ink discharge image data D1, the control unit 1 causes the linehead 6 (each head 60) to discharge the ink. Depending on the print content, there may be the nozzle 7 having a small number of times of ink discharges during the printing on one page. In addition, there may be a nozzle that does not discharge any ink even once during the one-page printing. The smaller the number of times of ink discharges, the viscosity of the ink in the nozzle 7 tends to be higher. Even during the printing, evaporation may progress in the nozzle 7 with a small number of times of ink discharges.

Then, the control unit 1 puts the nozzle 7, which has a small amount of ink discharge during the printing on one page, into the drying prevention state. Hereinafter, an example of the drying prevention control during the printing will be described, with reference to FIGS. 7 and 8.

Start in FIG. 7 is the time point when the generation of the ink discharge image data D1 for one page is completed for printing. In the case of a printing job that continuously prints a plurality of sheets of paper (pages), a flow chart shown in FIG. 7 is executed per page.

First, the control unit 1 (image processing circuit 11) analyzes the ink discharge image data D1 on one page, and recognizes a continuous non-discharge section A1 for each nozzle 7 (step #11). Specifically, for each nozzle 7, the control unit 1 (image processing circuit 11) recognizes, as the continuous non-discharge section A1, a section in the sub-scanning direction, which does not discharge the ink, is equal to or more than the reference number of dots.

FIG. 8 shows an example of the ink discharge image data D1. The horizontal direction of FIG. 8 shows a direction in which the nozzles 7 are arranged (main scanning direction). The vertical direction of FIG. 8 shows the paper conveyance direction (sub-scanning direction). In addition, in FIG. 8, one block indicates one dot. Any dot including a white circle shows a dot that discharges the ink. Any dot not including a white circle shows a dot that does not discharge the ink. Also, a shading in FIG. 8 shows an example of the continuous non-discharge section A1 recognized by the control unit 1.

The reference number of dots is specified in advance. The memory unit 2 non-volatilely memorizes the reference number of dots. The reference number of dots is determined so as to satisfy, for example, the following relation.

T0>T1+T2 (Equation)

T0 is the time required for printing the section of the reference number of dots.
T1 is the time required from the start of voltage application to the completion of the transition to the drying prevention state (the time required to deform the first piezoelectric actuator 81 and the second piezoelectric actuator 82).
T2 is the time from when the voltage application to the first piezoelectric actuator 81 and the second piezoelectric actuator 82 is released until the liquid level (interface 95) of the ink arrives at (returns to) the front end (discharge port) of the nozzle 7. In this way, the reference number of dots can be determined in consideration of the time required for transition to the drying prevention state and the time required for releasing the drying prevention state and returning to the state in which the ink can be discharged.

In the example of FIG. 8, the reference number of dots is 12. The reference number of dots may be 12 or less or 12 or more. The example of FIG. 8 is merely one example.

Then, the control unit 1 confirms whether or not there is a continuous non-discharge section A1 in any of the nozzles 7 (step #12). When printing an image with a lot of ink discharges such as a solid image, there may be a case in which no nozzle 7 has the continuous non-discharge section A1. In addition, the control unit 1 may recognize a plurality of continuous non-discharge sections A1 for one nozzle 7.

If there is no continuous non-discharge section A1 in any of the nozzles 7 (No in step #12), the control unit 1 notifies each driver circuit 61 that there is no nozzle 7 that has to be put into the drying prevention state during the printing (step it 13→End). In this case, the control unit 1 does not put any nozzle 7 into the drying prevention state.

On the other hand, if there is a continuous non-discharge section A1 in any of the nozzles 7 (Yes in step #12), the control unit 1 determines the start time point and end time point of the drying prevention state, per nozzle 7, for each continuous non-discharge section A1 (step #14). The start time point is the time point when the voltage application (deformation) to the first piezoelectric actuator 81 and the second piezoelectric actuator 82 is started. The end time point is the time point when the voltage application (deformation) to the first piezoelectric actuator 81 and the piezoelectric actuator 82 is completed and the ink supply path 92 is opened.

In FIG. 8, a Δ mark shows an example of the start time point set by the control unit 1. A □ mark shows an example of the end time point set by the control unit 1. FIG. 8 shows an example in which the control unit 1 sets the end time point a few dots before the ink is discharged. FIG. 8 shows an example of setting the start time point and end time point of the drying prevention state based on the dot.

For example, in FIG. 8, for the nozzle 7 having the number 8, the control unit 1 sets the 1st line (first line, drawing start time) in the sub-scanning direction as the start time point. Also, the control unit 1 sets the 14th line in the sub-scanning direction as the end time point. In this case, the control unit 1 puts the 8th nozzle 7 into the drying prevention state at the start time point of drawing the 1st line. The control unit 1 releases the drying prevention state of the 8th nozzle 7 at the time of discharging the 14th line ink.

When determining the start time point and the end time point, the control unit 1 notifies the driver circuit 61 of the start time point and the end time point for each nozzle 7 (step #15). In other words, for each nozzle 7, the control unit 1 instructs the time point for entering the drying prevention state and the time point for releasing the drying prevention state. Based on this instruction, the driver circuit 61 carries out transition to and release from the drying prevention state for each nozzle 7, during the printing on one page (step #16→End).

(Drying Prevention Control when Printing Job is Completed)

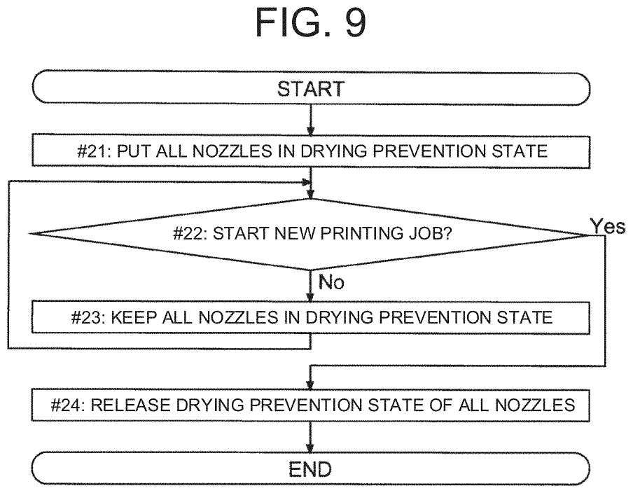

Next, an example of the drying prevention control at the completion of the printing job of the printer 100 according to the embodiment will be described, with reference to FIG. 9. FIG. 9 is a diagram showing an example of the drying prevention control at the completion of the printing job of the printer 100 according to the embodiment.

Start in FIG. 9 is the time point when the ink discharge of the last page of the printing job is finished. In other words, it can be said to be the time point when the printing job is completed. At this time, the control unit 1 puts all the nozzles 7 into the drying prevention state (step #21). The control unit 1 instructs each driver circuit 61 to make transition to the drying prevention state of all nozzles 7. The control unit 1 causes the driver circuit 61 to deform each first piezoelectric actuator 81 and each second piezoelectric actuator 82.

Next, the control unit 1 confirms whether or not to start a new printing job (step #22). For example, when the communication unit 5 receives any data for the new printing job, the control unit 1 determines to start the new job.

When the new printing job is not started (No in step #22), the control unit 1 keeps all the nozzles 7 in the drying prevention state (step #23). Then, the control unit 1 performs the step #22 (return to step #22). The control unit 1 keeps all nozzles 7 in the drying prevention state, from the end of the printing job to the start of a new printing job.

When starting the new printing job (Yes in step #22), the control unit 1 releases the drying prevention state of all the nozzles 7 (step #24). Specifically, the control unit 1 instructs each driver circuit 61 to release the drying prevention state of all the nozzles 7. The control unit 1 causes the driver circuit 61 to release the deformation (voltage application) of each first piezoelectric actuator 81 and each second piezoelectric actuator 82. With this, in each nozzle 7, the interface 95 of the ink moves to the opening (discharge port) of the nozzle 7. Then, this flow ends. When the new printing job is completed, this flow chart will start again.

The printer 100 may include a cap member 107 (see FIG. 2). The cap member 107 covers the lower surface of the linehead 6 (each head 60). The lower surface of the linehead 6 is a surface on which the openings of the nozzles 7 are arranged. The cap member 107 is, for example, made of rubber. The cap member 107 is fitted to the lower surface of the head 60 so as to seal the nozzle 7.

The distance between the linehead 6 (each head 60) and the conveyance unit 44 (conveyance belt 46) is narrow. When the cap member 107 covers the lower side of the linehead 6, it is necessary to increase the distance between the linehead 6 and the conveyance unit 44. Therefore, the printer 100 has an elevation mechanism 108 (see FIG. 2). The elevation mechanism 108 is a mechanism for moving the conveyance unit 44 up and down. The operation panel 3 receives an instruction for mounting the cap member 107. When the operation panel 3 receives the mounting instruction, the control unit 1 causes the elevation mechanism 108 to lower the position of the conveyance unit 44. This creates, between the linehead 6 and the conveyance unit 44, a gap for inserting the cap member 107.

After the distance between the linehead 6 and the conveyance unit 44 is increased, the cap member 107 is mounted to the lower surface of the linehead 6. The printer 100 may include an attachment/detachment device 109 for attaching/detaching the cap member 107 (see FIG. 2). When the distance between the linehead 6 and the conveyance unit 44 is increased, the attachment/detachment device 109 moves the cap member 107 to the lower surface of the linehead 6. After that, the attachment/detachment device 109 raises the cap member 107 and fits the cap member 107 to the lower surface of the head 6.

If the user desires to return to the state where printing can be performed, the user inputs a return instruction to the operation panel 3. When receiving the return instruction, the control unit 1 causes the attachment/detachment device 109 to lower the cap member 107. With this, the cap member 107 is removed from the linehead 6. Next, the control unit 1 has the attachment/detachment device 109 cause the cap member 107 to evacuate from between the linehead 6 and the conveyance unit 44. After the cap member 107 evacuates, the control unit 1 causes the elevating mechanism 108 to raise the conveyance unit 44. The control unit 1 returns the gap between the lower surface of the linehead 6 and the conveyance unit 44 (conveyance belt 46) to the interval at the time of printing.

In this way, the image forming apparatus (printer 100) according to the embodiment includes the linehead 6 and the control unit 1 for controlling the linehead 6. The linehead 6 includes the common ink chamber 93, a plurality of the nozzles 7, the individual ink flow path 91, the ink supply path 92, the first piezoelectric actuator 81, and the second piezoelectric actuator 82. The individual ink flow path 91 is provided for each nozzle 7. One end of the individual ink flow path 91 is connected to the nozzle 7. The ink supply path 92 is provided for each individual ink flow path 91. The ink supply path 92 has one end connected to the other end of the individual ink flow path 91 and the other end connected to the common ink chamber 93. The first piezoelectric actuator 81 is provided for each individual ink flow path 91. The first piezoelectric actuator 81 can be deformed in the direction in which the capacity of the individual ink flow path 91 increases and the direction in which the capacity of the individual ink flow path 91 decreases. The second piezoelectric actuator 82 is provided for each ink supply path 92. When putting the nozzle 7 into the drying prevention state, the control unit 1 deforms the first piezoelectric actuator 81 in the direction of increasing the capacity of the individual ink flow path 91, to thereby draw the interface 95 of the ink to inside the nozzle 7. Further, the control unit 1 deforms the second piezoelectric actuator 82, to thereby cause the second piezoelectric actuator 82 to close the connected ink supply path 92 connected to the individual ink flow path 91 that drew in the interface 95 of the ink.

When achieving the drying prevention state, the first piezoelectric actuator 81 is operated and the interface 95 of the ink at the nozzle 7 part is drawn to inside (back side) of the nozzle 7. Further, the second piezoelectric actuator 82 is operated to thereby stop the flow of the ink. By doing these, it is possible to keep the state where the interface 95 of the ink is drawn to inside the nozzle 7. When the interface 95 of the ink is drawn to inside the nozzle 7, the component evaporated in the nozzle 7 (inside the cylinder) stays at a high concentration. It is known that this suppresses (slows down) evaporation of the component of the ink. Therefore, merely operating the first piezoelectric actuator 81 and the second piezoelectric actuator 82 can rapidly shift the nozzle 7 to the drying prevention state. Even during the printing, the nozzle 7 can be rapidly put into the drying prevention state. Also, merely releasing the first piezoelectric actuator 81 and the second piezoelectric actuator 82 can release the drying prevention state. Printing can be immediately restarted.

Moreover, since the ink supply path 92, the first piezoelectric actuator 81, and the second piezoelectric actuator 82 are provided for each nozzle 7, the nozzle 7 can be put into the drying prevention state per nozzle unit. During the printing, switching the not-to-be used nozzle 7 to the drying prevention state can suppress the drying of the nozzle 7 per nozzle unit. It is possible to eliminate any discharge defect such as clogging.

The ink supply path 92 is thinner than the individual ink flow path 91. Since the ink supply path 92 is thin, the ink supply path 92 can be easily closed by the second piezoelectric actuator 82. Also, since the ink supply path 92 is thin, the influence of the operation (deformation) of the first piezoelectric actuator 81 and second piezoelectric actuator 82 can be less likely to reach any other nozzle 7.

The protrusion 94 is provided on the ink supply path 92. The protrusion 94 protrudes in the direction toward the second piezoelectric actuator 82. The protrusion 94 protrudes in the direction facing the direction in which the second piezoelectric actuator 82 at the time of deformation applies the pressure to the ink supply path 92. Providing the protrusion 94 can decrease the deformation amount of the second piezoelectric actuator 82 for closing the ink supply path 92. The pressure and the deformation amount required to block the flow of the ink can be minimized

Based on the image data, the control unit 1 causes the head 60 to discharge the ink. Based on the image data, the control unit 1 recognizes, for each nozzle 7, the continuous non-discharge section A1 in which a section not discharging the ink is equal to or more than the reference number of dots specified in advance. During the printing of one page, the control unit 1 puts the nozzle 7 with the continuous non-discharge section A1 into the drying prevention state throughout the continuous non-discharge section A1. During the printing of one page, drying can be prevented for the nozzle 7 which has a small number of times of ink discharges. It is possible to suppress the drying of the nozzle 7 per nozzle unit, depending on the printing content.

When the ink discharge of the last page of the printing job is completed, the control unit 1 puts all the nozzles 7 into the drying prevention state. When the printing job is completed, drying of all the nozzles 7 can be suppressed. In the period until the next printing job, drying of the nozzle 7 can be suppressed. Printing can be immediately restarted by merely releasing the deformation of the first piezoelectric actuator 81 and second piezoelectric actuator 82.

While some embodiments and modification examples of this disclosure have been described above, they are in no way meant to limit the scope of this disclosure, which thus allows for various modifications within the spirit of this disclosure.

This disclosure is applicable to an image forming apparatus including an image sensor that reads fed paper.

What is claimed is:

1. An image forming apparatus, comprising:
a linehead including a common ink chamber, a plurality of nozzles, an individual ink flow path, an ink supply path, a first piezoelectric actuator, and a second piezoelectric actuator; and
a control unit for controlling the linehead,
wherein
the individual ink flow path is provided for each of the plurality of nozzles, and has one end connected to the nozzle of the plurality of nozzles,
the ink supply path is provided for each individual ink flow path, having one end connected to the other end of the individual ink flow path, and having the other end connected to the common ink chamber,
the first piezoelectric actuator is provided for the individual ink flow path, and is capable of deforming in a direction in which a capacity of the individual ink flow path increases and in a direction in which the capacity of the individual ink flow path decreases,
the second piezoelectric actuator is provided for the ink supply path and
when putting the nozzle into a drying prevention state,
the control unit
deforms the first piezoelectric actuator in the direction in which the capacity of the individual ink flow path increases, to thereby draw an interface of ink to inside the nozzle, and
deforms the second piezoelectric actuator, to thereby cause the second piezoelectric actuator to close the ink supply path connected to the individual ink flow path in which the interface of the ink was drawn.

2. The image forming apparatus according to claim 1, wherein the ink supply path is thinner than the individual ink flow path.

3. The image forming apparatus according to claim 1, wherein
a protrusion is provided on the ink supply path, and
the protrusion protrudes in a direction toward the second piezoelectric actuator, and
protrudes in a direction facing a direction in which the second piezoelectric actuator, when deformed, applies a pressure to the ink supply path.

4. The image forming apparatus according to claim 1, wherein
the control unit,
based on image data, causes the linehead to discharge the ink,
based on the image data, recognizes, for each nozzle, a continuous non-discharge section in which a section not discharging the ink is equal to or more than a reference number of dots specified in advance, and
during a printing of one page, puts the nozzle with the continuous non-discharge section into the drying prevention state throughout the continuous non-discharge section.

5. The image forming apparatus according to claim 1, wherein
when ink discharge of a last page of a printing job is completed,
the control unit puts all of the nozzles in the drying prevention state.
